(19) United States
(12) Patent Application Publication
(10) Pub. No.: US 2010/0306041 A1
(43) Pub. Date: Dec. 2, 2010

(54) METHOD AND SYSTEM FOR DISTRIBUTING LEAD GENERATION FEES

(76) Inventors: Michael Karczewski, Plainfield, IL (US); James Johnson, Elmwood Park, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 12/787,818

(22) Filed: May 26, 2010

Related U.S. Application Data
(60) Provisional application No. 61/182,465, filed on May 29, 2009.

(51) Int. Cl. G06Q 30/00; G06Q 20/00; G06Q 40/00

(52) U.S. Cl. 705/14.16

(57) ABSTRACT

A system for distributing a loan lead generation fee, including: a computer including a processor in communication with a computer-readable medium and a network, the computer-readable medium having a database stored thereon, the database including a listing of the plurality of participants and hierarchical relationships therebetween; a participant input subsystem operably connected to the computer and to the network; a lead generation fee payment subsystem for receiving the lead generation fee that is generated upon closing of the loan; a calculation subsystem for calculating loan lead generation fee payments to be made to at least one participant, wherein the calculation subsystem calculates a fraction of the loan lead generation fee payment to pay the at least one participant based on the hierarchical relationship between the at least one participant and the plurality of participants; and a payment subsystem for distributing a payment to the at least one participant.

### CROSS REFERENCE TO RELATED APPLICATIONS

This application claims priority to U.S. Provisional Application No. 61/182,465, filed May 29, 2009, which is incorporated herein by reference in its entirety.

### BACKGROUND

1. Field of the Invention

The present invention relates to a method and a system for distributing lead generation fee payments to individuals, businesses, and not-for-profit entities.

2. Background of the Invention

Upon closing of a loan (e.g. a mortgage), a lead generation fee is often paid to a lender or broker who provided the lead which resulted in the loan being issued.

### SUMMARY

In one embodiment, the invention provides a system for distributing a lead generation fee from a loan to at least one of a plurality of participants. The system includes a computer including a processor in communication with a computer-readable medium and a network, the computer-readable medium having a database stored thereon, the database including a listing of the plurality of participants and hierarchical relationships therebetween; a participant input subsystem operably connected to the computer and to the network; a lead generation fee payment subsystem for receiving the lead generation fee that is generated upon closing of the loan; a calculation subsystem for calculating loan lead generation fee payments to be made to at least one participant, wherein the calculation subsystem calculates a fraction of the loan lead generation fee payment to pay the at least one participant based on the hierarchical relationship between the at least one participant and the plurality of participants; and a payment subsystem for distributing a payment to the at least one participant.

In another embodiment the invention provides a method of distributing a portion of a loan lead generation fee. The method includes registering a first participant comprising obtaining first participant contact information; registering a second participant comprising obtaining second participant contact information; recording a first referral relationship between the first participant and the second participant; receiving a request for a loan from the second participant; forwarding second participant information to a loan vendor; receiving from the loan vendor a lead generation fee and second participant loan information; calculating a first portion of the lead generation fee based on the first referral relationship; and distributing the first portion of the lead generation fee to the first participant.

Other aspects of the invention will become apparent by consideration of the detailed description and accompanying drawings.

### BRIEF DESCRIPTION OF THE DRAWINGS

FIG. 1 shows a diagram of a computer system for carrying out aspects of the present invention;

FIG. 2 shows a diagram of the system including the hierarchical relationships between first, second, and third participants; and

FIG. 3 shows a diagram of the system including the hierarchical relationships between an entity and first and second participants.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The present invention discloses method and system for collecting referrals for loans, tracking relationships between the referral sources, collecting lead generation fees for loans that are funded, and distributing portions of the lead generation fees to the referral sources according to the relationship of the referral source to the party who obtained the loan.

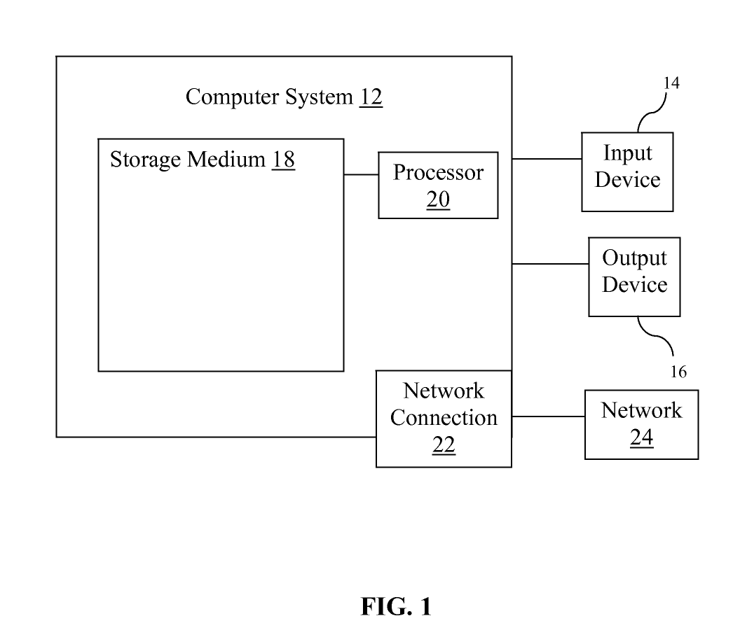

In embodiments of the invention, aspects of a referral system 10 are carried out by a computer system 12 which has an input device 14, an output device 16, a computer-readable storage medium 18, and a processor 20 (FIG. 1). Possible input devices 14 include a keyboard, a computer mouse, a touch screen, and the like. Output devices 16 include a cathode-ray tube (CRT) computer monitor, a liquid-crystal display (LCD) computer monitor, and the like. Storage media 18 include various types of memory such as a hard disk, RAM, flash memory, and other magnetic, optical, physical, or electronic memory devices. The processor 20 is any typical computer processor for performing calculations as well as for directing other functions related to performing input, output, calculation, and display of data associated with the referral system 10. Those aspects of the referral system 10 that are implemented on the computer system 12 comprise instructions and data that are stored on the storage medium 18. The data associated with the referral system 10 can include image, text, numerical, and other types of data. In one embodiment, the computer system 12 includes a server and in one particular embodiment the server is configured to operate as a web server. The computer system 12 can also include a network connection 22 which in turn can connect to a computer network 24. The network connection 22 can serve as an additional source of input and output for the computer system 12.

In various embodiments, participants contact a service provider 100, for example through a web site operated by or on behalf of the service provider 100, and register with the service provider 100. The service provider 100 operates one or more hardware components that effectuate embodiments of the referral system 10. Generally, at least one of the participants is considering obtaining a loan, e.g. for a purchase of a property such as a home or for refinancing an existing loan. The loan can be for purchase or refinancing of a residential or commercial property or a construction loan, and can be obtained through any number of private or government-sponsored programs including a VA (Veterans Affairs) loan or an FHA (Federal Housing Administration) loan, to name a few possibilities.

Other participants may not be actively seeking a loan but instead may register with the service provider 100 in order to recruit others to register with the system 10 and to thereby establish referral relationships with the others.

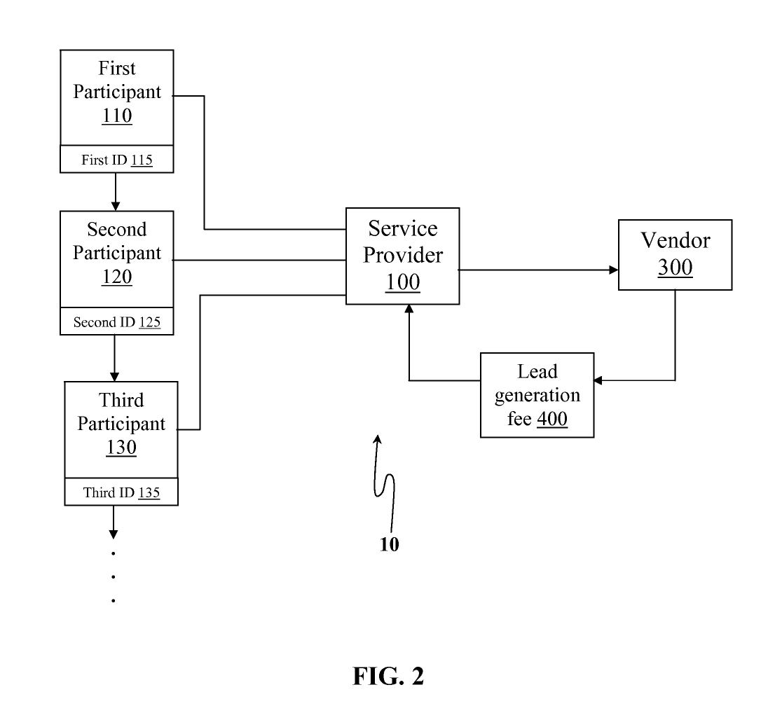

In one embodiment of the referral system 10, when a first participant 110 registers with the service provider 100, a participant account is created for the first participant 110, who is also issued a first identification number 115 (FIG. 2). In some embodiments, a personal web site (e.g. having an address that is specified by a uniform resource locator, or URL) is generated for the first participant 110; the first participant 110 can then share the URL of the web site with potential contacts to assist them in registering with the service provider 100. The first participant 110 can also use the web site to manage his or her account. When the first participant 110 subsequently refers a second participant 120 to the service provider 100, the first participant 110 provides the second participant 120 with the first identification number 115. When the second participant 120 registers with the service provider 100, the second participant 120 enters the first identification number 115 into the referral system 10, thereby establishing a referral relationship between the first participant 110 and the second participant 120, with the first participant 110 being “above” the second participant 120 for referral purposes. A participant account is created for the second participant 120 and the second participant 120 is issued a second identification number 125.

When the second participant 120 refers others to the referral system 10 of the service provider 100, the second participant 120 provides the others with the second identification number 125, which the others enter when they register with the service provider 100. When the others enter the second identification number 125, the others establish referral relationships with the second participant 120 as well as with the first participant 110. Thus, if one of the other participants, for example a third participant 130, enters the second identification number 125 when registering with the service provider 100, then this establishes a referral relationship between the third participant 130 and the second participant 120. Given the preexisting referral relationship between the first participant 110 and the second participant 120, then the third participant 130 establishes an indirect referral relationship with the first participant 110. To the extent that participants may refer other participants to the service provider 100, the participants in some embodiments are referred to as “representatives” of the service provider 100. In various embodiments, the participants' relationship to the service provider 100 is that of an independent contactor, with the relationship lasting for various time periods such as one month, one year, or any other time period agreed upon between the service provider 100 and the particular participant.

In various embodiments, a participant who refers another participant to the service provider 100 is the sponsor of the other participant, and the identification number that is entered by the other participant is called the sponsor identification number. In the example above, the first participant 110 is the sponsor of the second participant 120 and the first identification number 115 serves as the sponsor identification number.

The following is a description of how participants can work with the service provider 100 to use the referral system 10 to obtain a loan according to various embodiments of the invention, using the first participant 110 as an example. As part of the process of registering with the referral system 10, the first participant 110 enters various contact and other information, including one or more of the participant's name; postal address (which can include house number, street name, city, state, zip code, and/or country); email address; home telephone number; work telephone number; mobile telephone number; employer name; the identification number of another participant who referred the first participant 110 to the service provider 100, if applicable (i.e. the sponsor identification number); an indication that the first participant agrees to any terms and conditions set forth by the service provider 100; an indication of whether the first participant is an individual, a business entity, or a not-for-profit entity; an identifier such as the last four digits of the participant's taxpayer identification number (TIN) or Social Security number (SSN); and an indication of whether the participant is seeking a loan. In some embodiments, when the first participant 110 initially registers with the referral system 10, she may not be seeking a loan but instead registers in order to refer other participants to the service provider 100. The referred participants in turn may obtain loans or may simply refer more participants to the service provider 100. Nevertheless, the first participant 110 may indicate to the referral system 10 at a later time that she is interested in obtaining a loan by making a request to the service provider 100. In some embodiments, a participant can make the request in a number of ways, including electronically (e.g. via email or other computer-based communication), on paper, via telephone, or in person. Another mechanism that is available to an existing participant to indicate his or her interest in obtaining a loan is by selecting an option that is available in the participant's “back office,” which is a portion of the participant's web site used for managing the participant's account with the service provider 100, to inform the service provider 100 that the participant is interested in obtaining a loan.

In general, when the first participant 110 indicates that she would like to obtain a loan, her contact information is transmitted to one or more outside vendors 300 (in some embodiments using the network 24), where the vendors 300 can include mortgage brokers or other loan brokers as well as traditional lending institutions such as banks (FIG. 2). The vendors 300 then work directly with the first participant 110 to arrange a loan. In certain embodiments, the vendor 300 is a loan originator. The contact information that is transmitted can include one or more of the participant's name, address, telephone number (one or more of home, work, or mobile number), email address, and the last four digits of the participant's SSN or TIN, the latter for identification purposes only. In addition, in certain embodiments the transmitted information can include the participant's identification number issued by the service provider 100. The contact information can be transmitted in a number of ways, including by telephone, paper, or electronically (e.g. by email or other computer network-based communication). In one particular embodiment, a participant indicates her interest in obtaining a loan by entering contact information on a web page at the service provider's 100 web site. When the participant submits the information (e.g. by selecting a button on the web page), the participant's web browser is redirected to a secure web site operated by a vendor 300, where the participant then enters additional loan-related or other information.

In various embodiments, the first participant 110 provides the vendor 300 with loan-related information which is needed for setting up a loan. For example, the information provided by the first participant 110 can include, without limitation, the type of property (e.g. residential, commercial), the location of the property, the purchase price of the property, the down payment amount, the loan amount, the first participant's 110 financial profile (e.g. income, savings, debts, etc.), the desired loan term (e.g. fifteen-, twenty-, thirty-year), and whether a fixed or adjustable-rate loan is preferred. In addition to obtaining loan-related information, the vendors 300 may perform additional steps such as running a credit check on the first participant 110. In certain embodiments, each vendor 300 works directly with the first participant 110, and in other embodiments the vendors 300 maintain a centralized database of participant contact and loan-related information and make this information available to the vendors 300. Regardless of how the participant contact and loan-related information is transmitted to the vendor 300, the first participant 110 works directly with the vendor 300 to finalize the details of the loan.

When the loan process is completed and the loan is funded, the vendor 300 who issues the loan pays a lead generation fee 400 to the service provider 100, in accordance with all applicable laws and regulations (FIG. 2). In general, the vendor 300 who originates the loan sells the loan on the secondary loan market, and the lead generation fee 400 is paid out of the proceeds of the secondary loan market sale. If not previously provided, the vendor 300 transmits to the service provider 100 information regarding the loan and the applicant, including for example the loan amount and the name and other contact information for the borrowers. The service provider 100 then uses this information to determine how to distribute the lead generation fee 400. In one particular embodiment, the vendor 300 transmits to the service provider 100 an amount of the net sale proceeds of the loan (e.g. in US dollars) along with identifying information, such as the identification number, for the participant who generated the lead (e.g. the loan applicant). In various embodiments, the vendor 300 transmits this information to the service provider 100 at various time intervals, including on a daily, weekly, or monthly basis, or other suitable time interval. The vendor 300 also transmits the lead generation fee 400 to the service provider 100, using a suitable payment mechanism such as electronic transfer or paper check, at suitable time intervals such as daily, weekly, monthly, or other time periods.

In one embodiment, the amount of the lead generation fee 400 is 0.8% of the loan amount, although other amounts of lead generation fees 400, based on other percentages or fixed amounts, are also possible. The service provider 100 in turn distributes portions of the lead generation fee 400 to the first participant 110 and any other participants who have a referral relationship with the first participant 110, as discussed above.

For example, in one particular embodiment, if the loan that is issued to the first participant 110 is for $250,000, the vendor 300 pays a lead generation fee 400 of $2,000 to the service provider 100 upon completion and funding of the loan. The first participant 110, who is the loan recipient and in some embodiments is referred to as the “lead generator,” receives 40%, or $800, of the lead generation fee 400. The participant who initially referred the first participant 110 to the service provider 100, referred to in some embodiments as the “sponsor” of the first participant 110, receives 14%, or $280, of the lead generation fee 400. The participant who referred the sponsor, who is two levels above the first participant 110, receives 8% of the lead generation fee 400. The remainder of the lead generation fee 400 can be divided up among the participants in a number of ways, generally according to how many levels away from the lead generator the particular participant is at, for example participants who are three to eight levels above the lead generator receive 5% of the lead generation fee 400, which in the example above is $100; and participants who are nine to twelve levels above the lead generator receive 2% of the lead generation fee 400, which in the example above is $40. Other mechanisms for dividing up the lead generation fee 400 are possible and are encompassed within the invention.

The maximum number of levels at which participants receive a portion of the lead generation fee 400 based on their referral relationships can be any number. In various embodiments, the maximum number is five, ten, twelve, fifteen, or any other number, which varies depending on factors such as the business goals of the service provider 100 and the expectations of the participants. The lead generation fee 400 can be divided up according to predetermined percentages, as discussed above, or by using fixed amounts that are determined ahead of time according to the approximate value of the loan. For example, Tables 1 and 2 below show examples of lead generation fee distributions for different ranges of loan amounts, for the lead generator plus twelve (Table 1) or fifteen (Table 2) levels of related participants above the lead generator. The distributions are shown as fixed amounts for the given ranges of loan amounts, although other amounts are also possible. In some embodiments, if there are less than twelve (as in Table 1) or fifteen (as in Table 2) related participants above the lead generator, then the remaining, undistributed portion of the lead generation fee 400 amount reverts to the service provider 100.

TABLE 1

| Amount of Loan | | | | | | | | | | | | | |
|---|---|---|---|---|---|---|---|---|---|---|---|---|---|
| generated | Lead | Level | Level | Level | Level | Level | Level | Level | Level | Level | Level | Level | Level |
| from Lead | Generator | 1 | 2 | 3 | 4 | 5 | 6 | 7 | 8 | 9 | 10 | 11 | 12 |
| 75,000-100,000 | 240 | 84 | 48 | 30 | 30 | 30 | 30 | 30 | 30 | 12 | 12 | 12 | 12 |
| 100,001-125,000 | 320 | 112 | 64 | 40 | 40 | 40 | 40 | 40 | 40 | 16 | 16 | 16 | 16 |
| 125,001-150,000 | 400 | 140 | 80 | 50 | 50 | 50 | 50 | 50 | 50 | 20 | 20 | 20 | 20 |
| 150,001-175,000 | 480 | 168 | 96 | 60 | 60 | 60 | 60 | 60 | 60 | 24 | 24 | 24 | 24 |
| 175,001-200,000 | 560 | 196 | 112 | 70 | 70 | 70 | 70 | 70 | 70 | 28 | 28 | 28 | 28 |
| 200,001-225,000 | 640 | 224 | 128 | 80 | 80 | 80 | 80 | 80 | 80 | 32 | 32 | 32 | 32 |
| 225,001-250,000 | 720 | 252 | 144 | 90 | 90 | 90 | 90 | 90 | 90 | 36 | 36 | 36 | 36 |
| 250,001-275,000 | 800 | 280 | 160 | 100 | 100 | 100 | 100 | 100 | 100 | 40 | 40 | 40 | 40 |
| 275,001-300,000 | 880 | 308 | 176 | 110 | 110 | 110 | 110 | 110 | 110 | 44 | 44 | 44 | 44 |
| 300,001-325,000 | 960 | 336 | 192 | 120 | 120 | 120 | 120 | 120 | 120 | 48 | 48 | 48 | 48 |
| 325,001-350,000 | 1,040 | 364 | 208 | 130 | 130 | 130 | 130 | 130 | 130 | 52 | 52 | 52 | 52 |
| 350,001-375,000 | 1,120 | 392 | 224 | 140 | 140 | 140 | 140 | 140 | 140 | 56 | 56 | 56 | 56 |
| 375,001-400,000 | 1,200 | 420 | 240 | 150 | 150 | 150 | 150 | 150 | 150 | 60 | 60 | 60 | 60 |
| 400,001-409,999 | 1,280 | 448 | 256 | 160 | 160 | 160 | 160 | 160 | 160 | 64 | 64 | 64 | 64 |
| 410,000 and above | 640 | 224 | 128 | 80 | 80 | 80 | 80 | 80 | 80 | 32 | 32 | 32 | 32 |

TABLE 2

| Amount of Loan | | | | | | | | | | | | | | | | |
|---|---|---|---|---|---|---|---|---|---|---|---|---|---|---|---|---|
| generated | Lead | Level | Level | Level | Level | Level | Level | Level | Level | Level | Level | Level | Level | Level | Level | Level |
| from Lead | Generator | 1 | 2 | 3 | 4 | 5 | 6 | 7 | 8 | 9 | 10 | 11 | 12 | 13 | 14 | 15 |
| 75,000-100,000 | 315 | 117 | 72 | 45 | 45 | 45 | 45 | 45 | 45 | 18 | 18 | 18 | 18 | 18 | 18 | 18 |
| 100,001-125,000 | 420 | 156 | 96 | 60 | 60 | 60 | 60 | 60 | 60 | 24 | 24 | 24 | 24 | 24 | 24 | 24 |
| 125,001-150,000 | 525 | 195 | 120 | 75 | 75 | 75 | 75 | 75 | 75 | 30 | 30 | 30 | 30 | 30 | 30 | 30 |
| 150.001-175,000 | 630 | 234 | 144 | 90 | 90 | 90 | 90 | 90 | 90 | 36 | 36 | 36 | 36 | 36 | 36 | 36 |
| 175,001-200,000 | 735 | 273 | 168 | 105 | 105 | 105 | 105 | 105 | 105 | 42 | 42 | 42 | 42 | 42 | 42 | 42 |
| 200,001-225,000 | 940 | 312 | 192 | 120 | 120 | 120 | 120 | 120 | 120 | 48 | 48 | 48 | 43 | 48 | 48 | 48 |
| 225,001-250,000 | 945 | 351 | 216 | 135 | 135 | 135 | 135 | 135 | 135 | 54 | 54 | 54 | 54 | 54 | 54 | 54 |
| 250,001-275,000 | 1,050 | 390 | 240 | 150 | 150 | 150 | 150 | 150 | 150 | 60 | 60 | 60 | 60 | 60 | 60 | 60 |
| 275,001-300,000 | 1,155 | 429 | 264 | 165 | 165 | 165 | 165 | 165 | 165 | 66 | 66 | 66 | 66 | 66 | 66 | 66 |
| 300,001-325,000 | 1,260 | 468 | 288 | 180 | 180 | 180 | 180 | 180 | 180 | 72 | 72 | 72 | 72 | 72 | 72 | 72 |
| 325,001-350,000 | 1,365 | 507 | 312 | 195 | 195 | 195 | 195 | 195 | 195 | 78 | 78 | 78 | 78 | 78 | 78 | 78 |
| 350,001-375,000 | 1,470 | 546 | 336 | 210 | 210 | 210 | 210 | 210 | 210 | 84 | 84 | 84 | 84 | 84 | 84 | 84 |
| 375,001-400,000 | 1,575 | 585 | 360 | 225 | 225 | 225 | 225 | 225 | 225 | 90 | 90 | 90 | 90 | 90 | 90 | 90 |
| 400,001-409,999 | 1,680 | 624 | 384 | 240 | 240 | 240 | 240 | 240 | 240 | 96 | 96 | 96 | 96 | 96 | 96 | 96 |
| 410,000 and above | 1,120 | 416 | 256 | 160 | 160 | 160 | 160 | 160 | 160 | 64 | 64 | 64 | 64 | 64 | 64 | 64 |

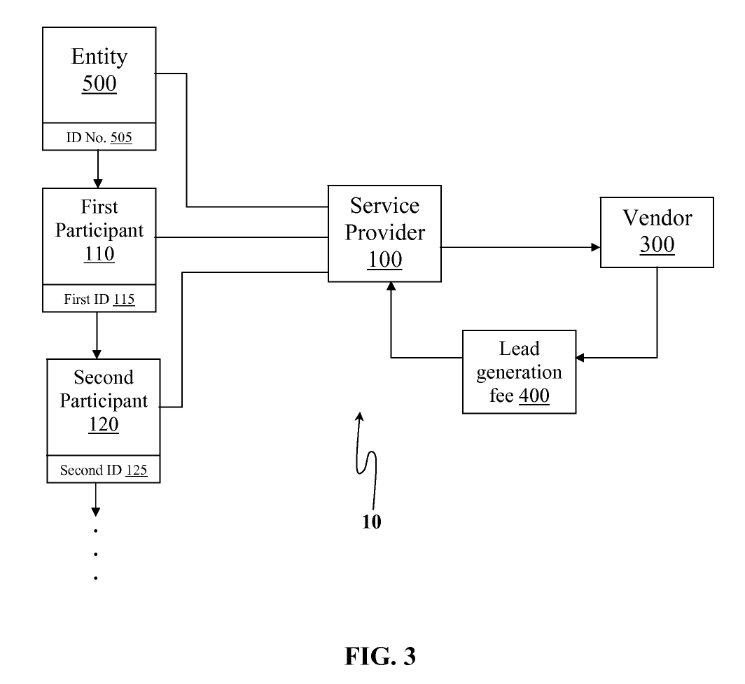

In some embodiments, one or more of the participants may be an entity 500, such as a business or a not-for-profit organization, rather than an individual. In these embodiments, the entity 500 registers with the referral system 10 in a similar manner to a participant who is an individual; for example, the entity 500 provides contact information to the service provider 100 and obtains an identification number 505 (FIG. 3). A web site, dedicated telephone number (e.g. a toll-free number), or other contact mechanisms may be set up to help the entity 500 collect referrals. The entity 500 then collects referrals on behalf of the service provider 100. If any of these referral participants obtains a loan through one of the vendors 300, then the entity 500 receives a share of the lead generation fee 400 as the first level referral, or sponsor, of the participant who actually obtains the loan (i.e. the lead generator). In various embodiments, the entity 500 may direct potential referral participants to the service provider 100 using a variety of mechanisms, including for example using a link on the web site of the entity 500 which directs the referral participants to the web site of the service provider 100. The participants who are referred to the service provider 100 enter the identification number of the entity 500 that referred them, thereby establishing a referral relationship between the participants and the entity 500 (FIG. 3). In some embodiments, the identification number of the referring entity 500 is automatically entered on the web site of the service provider 100 as a result of using the link. As with other participants, the entity 500 will receive varying fractions of any lead generation fees 400 that result from participants that have a referral relationship with the entity 500, depending on how many levels the entity 500 is removed from the participant who actually obtains the loan from which the lead generation fee 400 arises.

As mentioned above, the entity 400 may be a for-profit business or a not-for-profit organization. In various embodiments, the business referrals may represent the primary source of income for the entity or referrals may represent a supplementary source of passive income. In other embodiments, the business may share some portion of referral income with employees as part of an employee incentive program. The employees and their family and friends may be encouraged to participate.

Not-for-profit organizations may include religious organizations, educational institutions, or charitable foundations, to name a few. These organizations may recruit their members, alumni, or the general public to register with the service provider 100, including entering the organization's identification number, as a way to provide financial support for the organization.

As with any other referral participants, the supporters of an organization and/or the employees of a business can generate income by obtaining loans through the vendors 300 to which each supporter or employee was referred and also by referring more participants to the service provider 100.

As discussed above, in certain embodiments various aspects of the referral system 10 may be implemented on the computer system 12. The computer system 12 in some embodiments is connected to a network, e.g. the Internet, and may include a web server. Thus, the participants in certain embodiments can interact with the referral system 10 over the network, for example by the participant using a computer with a web browser to interact with the web server of the computer system 12 over the network. In some embodiments, participants may create and manage their own individual web sites, run from a web server operated by the service provider 100 or by another organization, each of which includes a link to the web site of the service provider 100.

In various embodiments of the invention, elements of the referral system 10 disclosed herein are implemented using the computer system 12 described above. For example, the referral system 10 may include a referral tracking subsystem which includes a record of the hierarchical referral relationships. The record of referral relationships may be maintained in a database that is stored on the computer-readable storage medium 18 of the computer system 12. When a loan is completed (i.e. funded) and the vendor 300 has paid a lead generation fee 400 to the service provider 100, a calculation subsystem determines how to distribute portions of the lead generation fee 400 to the participants. The calculation subsystem, which can include the processor 20, refers to the database to determine how to divide up the lead generation fee 400. The same or a different database can be used to keep track of how much each participant owes or is owed, how much has been paid to the participant, and other information such as the participant's contact information and preferences such as mode of payment (e.g. electronic transfer/direct deposit or paper check).

The referral system 10 can include a participant input subsystem for receiving input from participants. The participant input subsystem can include the input devices 14 and the output device 16 of the computer system 12 as well as the network 24, by which participants can transmit contact and other information.

The referral system 10 can also include an identification issuance subsystem for issuing a unique identification number to each participant. The identification issuance subsystem can include an identification number database, stored on the computer-readable storage medium 18 of the computer system 12, which maintains a listing of identification numbers and the participant to which each number has been assigned.

In some embodiments, the service provider 100 may charge the participants a fee (e.g. a weekly, monthly, or annual fee) for participating in the referral system 10. In one embodiment, the fee is charged directly to the participant, who must remit payment to the service provider 100, while in other embodiments the fee is deducted from lead generation fee payments and is only collected if the participant earns lead generation fee payments.

In some embodiments, the participant may be paid at irregular intervals based on when the participant earns money from a lead generation fee. Such payment may be made the same day that the vendor 300 transfers the lead generation fee 400 to the service provider 100, or within a day, two days, a week, two weeks, a month, or other suitable time period. Alternatively, lead generation fee payments may be made to participants every two weeks (e.g. every other Tuesday), twice a month (e.g. the 1^{st} and the 15^{th} of each month), once a month (e.g. the 1^{st} of each month), quarterly, or other suitable time period.

The referral system 10 can also include a payment subsystem for distributing payments to at least one of the plurality of participants. Payment may be made to the participants electronically (e.g. using the network connection 22 over the network 24) or a paper check may be printed and sent to the participant. Whether issuing a paper check or an electronic payment, the payment amount and other payee information may be transmitted over the network 24 using the network connection 22 to a third-party vendor who completes the transaction. In embodiments of the invention, various aspects of the referral system 10, such as initial registration and tracking of referral relationships, may be managed internally by the service provider 100 or may distributed among one or more third-party vendors.

Thus, the invention provides, among other things, a method and a system for distributing a portion of a loan lead generation fee. Various features and advantages of the invention are set forth in the following claims.

What is claimed is:

1. A system for distributing a lead generation fee from a loan to at least one of a plurality of participants, the system comprising:
a computer comprising a processor in communication with a computer-readable medium and a network, the computer-readable medium having a database stored thereon, the database including a listing of the plurality of participants and hierarchical relationships therebetween;
a participant input subsystem operably connected to the computer and to the network;
a lead generation fee payment subsystem for receiving the lead generation fee that is generated upon closing of the loan;
a calculation subsystem for calculating loan lead generation fee payments to be made to at least one participant, wherein the calculation subsystem calculates a fraction of the loan lead generation fee payment to pay the at least one participant based on the hierarchical relationship between the at least one participant and the plurality of participants; and
a payment subsystem for distributing a payment to the at least one participant.

2. The system of claim 1, wherein a participant is one of an individual, a not-for-profit organization, and a business.

3. The system of claim 1, wherein the payment subsystem makes payments using at least one of an electronic transfer and a printed check.

4. A method of distributing a portion of a lead generation fee from a loan, comprising:
registering a first participant comprising obtaining first participant contact information;
registering a second participant comprising obtaining second participant contact information;
recording a first referral relationship between the first participant and the second participant;
receiving a request for a loan from the second participant;
forwarding second participant information to a loan vendor;
receiving from the loan vendor a lead generation fee and second participant loan information;
calculating a first portion of the lead generation fee based on the first referral relationship; and
distributing the first portion of the lead generation fee to the first participant.

5. The method of claim 4, wherein the first participant is one of an individual, a not-for-profit organization, and a business.

6. The method of claim 4, wherein the second participant is one of an individual, a not-for-profit organization, and a business.

7. The method of claim 4, wherein the payments are made using at least one of an electronic transfer and a printed check.

8. The method of claim 4, further comprising distributing a second portion of the lead generation fee to the second participant.
